(19) United States
(12) Patent Application Publication
(10) Pub. No.: US 2024/0305714 A1
(43) Pub. Date: Sep. 12, 2024

(54) Emergency Telephone and Methods of Placing Emergency Call Using Same

(71) Applicant: Med-Pat, Inc., Shrewsbury, NJ (US)

(72) Inventors: Samuel M. Zagha, Teaneck, NJ (US); George T. Buehl, Sylvania, OH (US)

(73) Assignee: Med-Pat, Inc., Shrewsbury, NJ (US)

(21) Appl. No.: 18/598,442

(22) Filed: Mar. 7, 2024

Related U.S. Application Data
(60) Provisional application No. 63/450,558, filed on Mar. 7, 2023.

(51) Int. Cl. H04M 3/51

(52) U.S. Cl. CPC H04M 3/5116; H04M 2242/04

(57) ABSTRACT

An emergency telephone includes a speaker, microphone, activation mechanism configured to be placed in at least a first state and a second state, and memory storing a programmed telephone number. When the activation mechanism is in the first state, the emergency telephone is inactive, and when the activation mechanism is in the second state, the emergency telephone is activated and automatically places a call to the programmed telephone number. A method of placing an emergency call with an emergency telephone having a speaker, a microphone, an activation mechanism, and a memory storing a programmed telephone number includes causing the activation mechanism to change from a first state in which the emergency telephone is inactive to a second state in which the emergency telephone is activated. The method further includes placing a call to the programmed telephone number automatically upon the activation mechanism being placed in the second state.

### RELATED APPLICATIONS

This application claims the benefit of priority to U.S. Provisional Patent Application No. 63/450,558 filed on Mar. 7, 2023, the entire disclosure of which is expressly incorporated herein by reference in its entirety.

### BACKGROUND

### Technical Field

The present invention relates generally to means for automatically contacting emergency services, and in particular, to a telephone that automatically contacts emergency services when taken off-hook.

### Related Art

It is known in the art to use a telephone to dial an emergency services number, such as 911. However, someone in need of emergency services may not be able, or have the time, to dial a telephone number due to immediate danger, injury, disability, etc. Additionally, even after calling emergency services, a caller may still face danger and not be able to stay by the telephone or continue to hold the handset. In such instances, the caller may drop the telephone handset and flee or hide from the danger despite still requiring emergency services. Without the caller on the line, emergency services can have difficulty discerning the type and severity of the emergency, and can also have difficulty monitoring the activity and ongoing emergency.

Accordingly, what is needed is a telephone that can automatically contact emergency services or another telephone number when activated, and/or can provide for continued emergency services monitoring even when a caller is no longer by the telephone.

### SUMMARY

The present invention relates to an emergency telephone that includes a speaker, a microphone, an activation mechanism configured to be placed in at least a first state and a second state, and a memory storing a programmed telephone number. When the activation mechanism is in the first state, the emergency telephone is inactive, and when the activation mechanism is in the second state, the emergency telephone is activated and automatically places a call to the programmed telephone number.

In some aspects, the emergency telephone can include a handset that can be placed in a resting position in which the activation mechanism is in the first state and the emergency telephone is inactive, and removed from the resting position to change the activation mechanism from the first state to the second state to cause the emergency telephone to be activated.

The present invention also relates to a method of placing an emergency call with an emergency telephone having a speaker, a microphone, an activation mechanism, and a memory storing a programmed telephone number. The method includes causing the activation mechanism to change from a first state in which the emergency telephone is inactive to a second state in which the emergency telephone is activated. The method further includes placing a call to the programmed telephone number stored in a memory automatically upon the activation mechanism being placed in the second state.

In some aspects, causing the activation mechanism to change from a first state in which the emergency telephone is inactive to a second state in which the emergency telephone is activated can include removing a handset of the emergency telephone from a resting position to cause the activation mechanism to change from the first state to the second state.

Other features will become apparent form the following detailed description considered in conjunction with the accompanying drawings. It is to be understood, however, that the drawings are designed as an illustration only and not as a definition of the limits of the invention.

### BRIEF DESCRIPTION OF THE DRAWINGS

The foregoing features of the present disclosure will be apparent from the following Detailed Description of the Invention, taken in connection with the accompanying drawings, in which:

FIG. 1 is a top plan view of a telephone of the present disclosure illustrating a base, e.g., cradle, and handset of the telephone separated;

FIG. 2 is a front view of the handset of FIG. 1 with the buttons thereof exposed;

FIG. 3 is a block diagram of the components of the telephone of the present disclosure;

FIG. 4 is a flowchart of a process for programming a voice recording onto the telephone of the present disclosure and for auto-dialing a saved telephone number;

FIG. 5 is a flowchart of a process of a “HOT MIC” feature of the telephone of the present disclosure; and

FIG. 6 is a flowchart of a process of an “AUTO DISCONNECT” feature of the telephone of the present disclosure.

### DETAILED DESCRIPTION

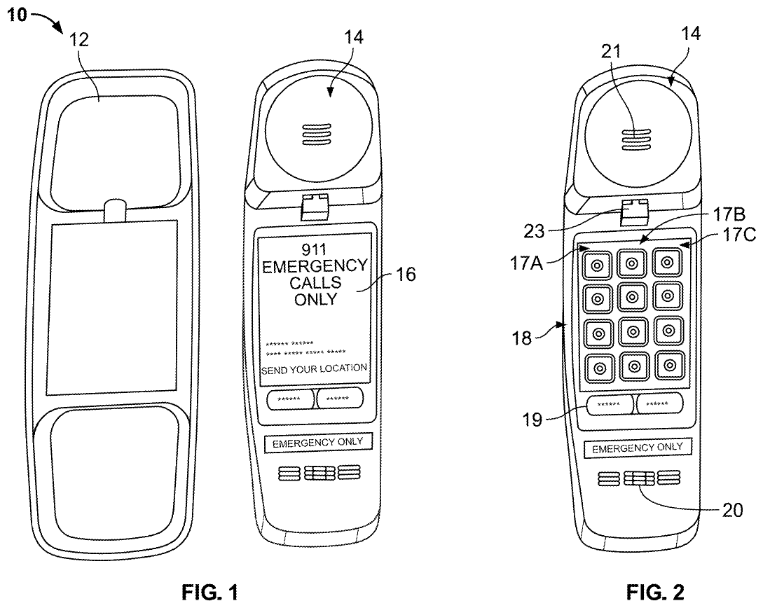

The present disclosure relates to an emergency telephone, as discussed in detail below in connection with FIGS. 1-6.

It should be understood that the term “on-hook” as used throughout the present application refers to a configuration of the telephone wherein the handset is at rest and/or the telephone is not activated to make a telephone call. For example, this can be when the hand set rests on top of the base, a surface, in a specific holder, etc., and no telephone call is initiated, or, where an activation mechanism of the telephone is in a first state. It should also be understood that the term “off-hook” as used throughout the present application refers to a configuration of the telephone where the telephone is activated, e.g., the handset is removed from the base and a dial tone is initiated, or, the activation mechanism is in a second state.

FIG. 1 is a top plan view of a telephone 10 of the present disclosure illustrating a base 12 and handset 14 thereof. In particular, FIG. 1 shows an topside of the base 12, e.g., the portion on which the handset 14 rests, and an underside of the handset 14, e.g., the portion that rests adjacent a user's face. The base 12 and handset 14 may be similar to conventional landline telephones known in the art. Alternatively, in some embodiments, the base 12 may be a modified TIC style cabinet from Med-Pat Inc. or any cabinet that securely maintains the handset 14 on-hook. In this regard, it is beneficial to utilize a telephone 10, such as the TIC style cabinet from Med-Pat Inc., that has a base 12 and handset 14 that securely connect to each other to prevent the handset from being accidentally knocked off-hook and automatically dialing emergency services, as discussed below. For example, a telephone 10 placed in a school hallway may be brushed against by children with backpacks, accidentally knocking the handset 14 off-hook if the handset 14 is not securely maintained.

Alternatively, the telephone 10 can be placed in a recess or shaped/designed with a flexible wall tab that allows the handset 14 to be easily released by an outward pulling motion, but cannot be easily dislodged for the base 12 by lateral force. The telephone 10 can include a cord (not shown) connecting the handset 14 and the base 12. The cord may be a configured with a combination of length and stiffness such that handset 14 cannot lay flat on the floor to ensure that sensors 22 of the telephone 10 are still triggered or activated when a user drops the handset 14. For example, the cord may be about four feet long in order to hold the handset 14 off of the floor when the base 12 is mounted at a height of more than four feet or four feet and six inches. However, in some aspects, it is contemplated that the handset 14 is a wireless handset that wirelessly communicates with the base 12, and does not include a cord.

The handset 14 can include an insert 16 situated in a middle portion of the surface of the handset 14 with an overlaid removable transparent window. The insert 16 can be made of paper, plastic, or any other suitable material. The insert 16 can be sized and shaped to allow users to easily create their own replacement inserts. For example, the insert 16 can be square shaped. In some embodiments, the insert 16 provides instructions as to the telephone numbers that are programmed in the telephone memory. The insert 16 covers and hides programming buttons 18, discussed in further detail below, and can be removable to reveal the buttons 18.

The telephone 10 can be programmed to automatically call an emergency number, for example 911, when the handset 14 is removed from the base 12, e.g., when the telephone is placed off-hook, as described in connection with FIG. 5. For example, the telephone 10 can be pre-programmed to automatically dial 9-1-1 when the handset 14 is taken off-hook. It should be understood that the telephone 10 can be programmed to automatically dial the emergency services number consistent with the requirements of a building's telephone or network service to ensure activation of the telephone system. For example, some telephone systems may require a pause and/or the number 9 to be dialed for activation. Accordingly, the telephone 10 can auto-dial as follows:
Pause then dial 9-1-1;
Pause, dial 9, pause, then dial 9-1-1;
Pause then dial 0 for an operator; or
Pause, dial 9, pause, then dial 0 for an operator.

The foregoing options are merely exemplary, and the present disclosure should not be understood to be limited thereto. Each of the foregoing can be automatically dialed once the telephone 10 is off-hook. The telephone 10 can be pre-programmed with a plurality of selectable default telephone numbers, which can be re-programmable as needed, e.g., through the use of a USB drive, suitable programming cable, digital communications means/methods/protocols, etc. In this regard, it should be understood that any of the programming required for operation of the telephone 10, including any features of the telephone 10 described herein, can be programmed or provided using a digital means, such as a USB communications method.

FIG. 2 is a front view of the handset 14 of FIG. 1 with the insert 16 removed thus exposing the keypad/buttons 18 thereof. The handset 14 can include any number of buttons 18 as necessary. For example, in some embodiments, the telephone 10 can include between one and twenty-four buttons 18, between ten and sixteen buttons 18, or between twelve to fourteen buttons 18. The handset 14 also includes a microphone 20, a speaker 21, and a switch 23. The switch 23 can be, for example, an electrical switch such as a spring-loaded hook-switch that controls whether the telephone 10 is on-hook or off-hook. Alternatively, the switch 23 can be a different activation mechanism that controls whether the telephone is activated, e.g., referred to herein as “off-hook,” or not activated, e.g., referred to herein as “on-hook.” For example, the switch 23, e.g., activation mechanism, can be, but is not limited to, an electrical sensor, a mechanical sensor, a magnetic sensor, an electrical switch, an optical switch, a magnetic switch, an accelerometer, a tilt switch, a gyroscope, a hall effect sensor, a button, a motion sensor, a tilt sensor, a capacitive sensor, a proximity sensor, a large push plate, which can be separate from the base 12 and handset 14 but in communication with the bus (e.g., by way of a wire that connects to the network interface 36, USB port 30, or other I/O port/jack of the telephone 10, or via wireless communication), a pull cord, which can be separate from the base 12 and handset 14 but in communication with the bus (e.g., by way of a wire that connects to the network interface 36, USB port 30, or other I/O port/jack of the telephone 10, or via wireless communication), or any other means of activation known in the art.

The buttons 18 may be arranged into columns organized by functionality. For example, the telephone 10 may include three columns 17A, 17B, 17C of buttons 18 as depicted in FIG. 2. A left column 17A may include four memory buttons 18. A center column 17B can include buttons 18 that can be used to select which telephone number to dial when the telephone 10 is taken off-hook, e.g., which of the four memory buttons of the left column 17A. In some embodiments, the buttons 18 in the middle column 17B can utilize one or more jumpers, which can also ensure that only one button 18 in the column 17B is actuated at a time. A right column 17C can include a button 18 designated to activate a recording function when actuated, as well as dummy buttons that have can be assigned other functions as desired or otherwise nonfunctional. Alternatively, the buttons 18 can include a plurality of buttons that, when actuated in a proper sequence, activate the recording function. The right column 17C may further include a button 18 designated for setting a timer function of the telephone 10, as further described below. Additionally, the handset 14 can include a send button 19.

Buttons 18 or insert 16 can include labeling. For example, each button 18 may be labeled to indicate the type of telephone number the button is associated with, for example fire, medical, maintenance, or security. In such embodiments, each labeled button 18 is associated with a programmed number that will dial the service indicated on the label.

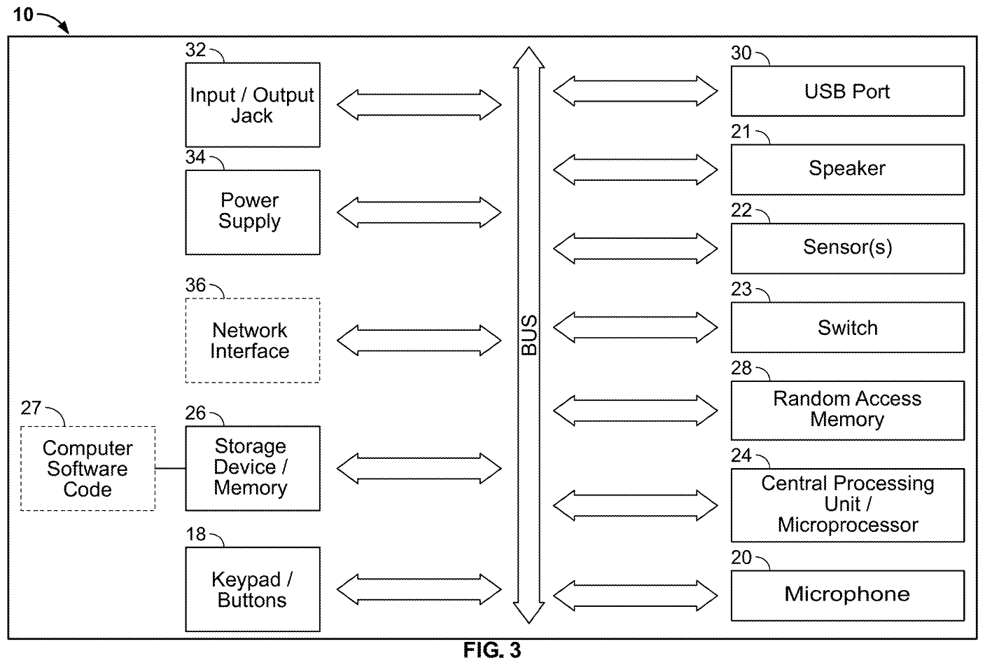

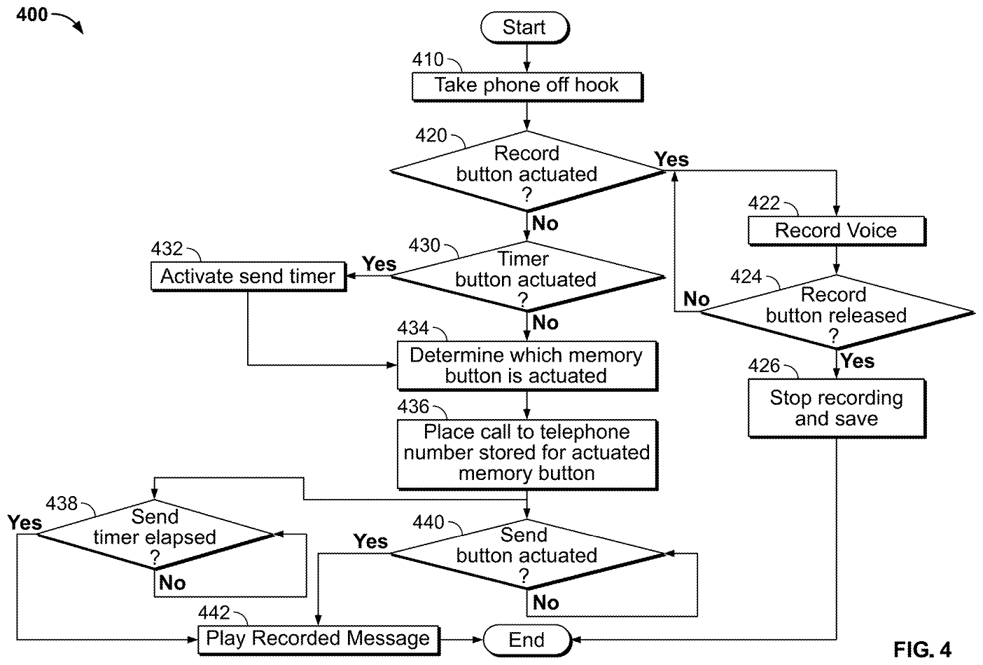

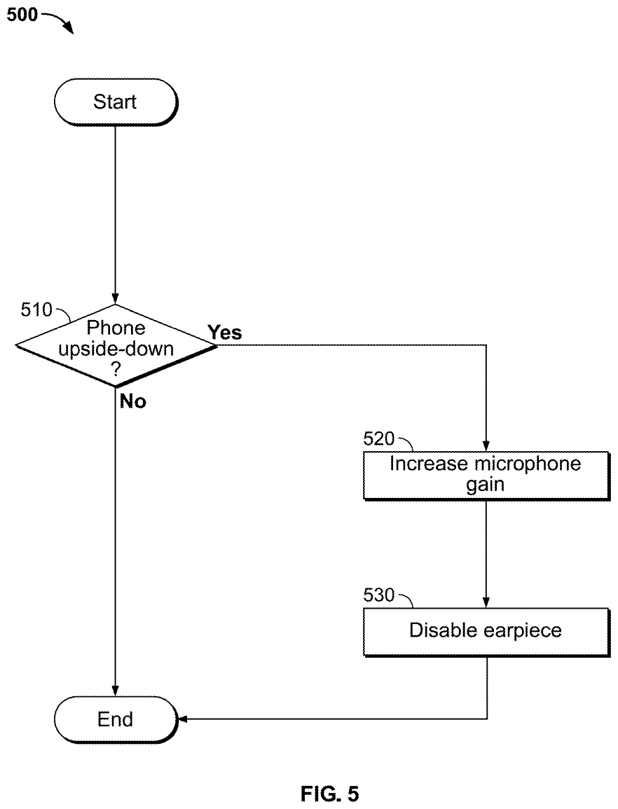

FIG. 3 is a block diagram of the components of the telephone 10 of the present disclosure. The telephone 10 can include a central processing unit/microprocessor 24, a storage device 26 and RAM 28. The central processing unit/microprocessor 24 could be a microprocessor, microcontroller, field-programmable gate array (FPGA), or any other suitable device. The memory 26 could be any suitable non-volatile memory such as flash memory, electrically-erasable, programmable, read-only memory (EEPROM), memory card, disk, or other suitable memory. Memory 26 may store preprogrammed numbers to be dialed by buttons 18 of the telephone 10 and voice recordings prepared, as described below in connection with FIG. 4. In some embodiments of more sophisticated telephones 10, memory 26 includes computer software code 27 for advanced telephone features such as sortable telephone lists, VOIP functionality, and the like. The central processing unit/microprocessor 24 is in electronic communication with the keypad/buttons 18, the microphone 20, the speaker 21, sensor(s) 22, the switch 23, an input/output jack 30, a USB port 32, and a power supply 34. As shown, these components can communicate with each other via a bus. In some embodiments, the telephone 10 may include an optional networking interface 36 for connection to an intranet or extranet to allow VoIP functionality.

The microphone 20 can be located within the handset 14. All of the components shown in FIG. 4 could be housed by a suitable housing, such as the housing of the handset 14 shown in FIG. 1. Additionally, it should be understood that the components shown in FIG. 3 can be divided between the handset 14 and the base 12, and connected by way of a cord. Input/output jack 32, USB port 30, and power supply 34 can be similar to jacks, ports, and power supplies known in the art. Additionally, as previously noted, the telephone 10 can be programmed through the USB port 30, or using another digital communications protocol.

Moreover, it should be understood that the components 18-36 shown in FIG. 4 (as well as the send button 17 shown in FIG. 2) need not be distributed amongst a handset 14 and a base 12. Instead, the telephone 10 can take the form of a speaker box, e.g., an intercom or emergency call box, in which the telephone 10 does not include a base 12 and a handset 14, but rather the telephone components 18-36 are positioned within a single housing similar to an intercom housing. In this configuration, the speaker 21 can be a large format speaker capable of producing louder sounds (e.g., higher decibel) and the microphone 20 can be an external microphone on the housing. Additionally, in this configuration, the switch 23 could be an activation mechanism that controls whether the telephone 10 is activated, e.g., “off-hook,” or not activated, e.g., “on-hook.” For example, the switch 23, e.g., activation mechanism, can be, but is not limited to, an electrical sensor, a mechanical sensor, a magnetic sensor, an electrical switch, an optical switch, a magnetic switch, an accelerometer, a tilt switch, a gyroscope, a hall effect sensor, a button, a motion sensor, a tilt sensor, a capacitive sensor, a proximity sensor, a magnetic sensor, a large push plate, which can be separate from the housing but in communication with the bus (e.g., by way of a wire that connects to the network interface 36, USB port 30, or other I/O port/jack of the telephone 10, or via wireless communication), a pull cord, which can be separate from the housing but in communication with the bus (e.g., by way of a wire that connects to the network interface 36, USB port 30, or other I/O port/jack of the telephone 10, or via wireless communication), or any other means of activation known in the art.

FIG. 4 is a flowchart 400 of a process for programming a voice recording onto the telephone 10 of the present disclosure, auto-dialing a saved telephone number, and a “LOCATION ANNOUNCEMENT” feature of the telephone 10. In step 410, a user takes the telephone 10 off-hook by removing the handset 14 from the base 12. In step 420, it is determined if a button 18, buttons, or predefined sequence of buttons, designated for recording an audio message has/have been actuated, e.g., the first button in the right-most column 17C. If a positive determination is made, then in step 422 a user records a message. The message may communicate a location of the telephone 10 and be used for a “LOCATION ANNOUNCEMENT” feature of the telephone 10 of the present disclosure, as described in further detail below. For example, the recorded message can be “Long Branch middle school, second floor, east hallway.” In step 424, a determination is made as to whether the record button 18, or buttons, has/have been released, or a predefined sequence of buttons have been pressed. If the record button 18, or buttons, has/have not been released, or the predefined sequence of buttons have not been pressed, then the process returns to step 422 where the recording is continued. If the record button 18, or buttons, has/have been released, or the predefined sequence of buttons have been pressed, then the process proceeds to step 426 where the recording functionality is stopped and the recording is saved to the memory 26. Accordingly, the telephone 10 records a user's message while the record button is pressed and stops recording once the record button is released.

While the foregoing discusses the use of a single button 18, e.g., a “record button,” for recording a message, it should be understood that alternative methods of activating the record message functionality and ending the record message functionality fall within the scope of the present invention. For example, a sequence of buttons or other specified action can be used to activate the audio message recording functionality, e.g., discussed in step 420, and to end the audio message recording functionality, e.g., discussed in step 424. Thus, the term “record button” is used for illustrative purposes only.

It should be understood that an action should be taken prior to using the record function in order to prevent the telephone 10 from automatically dialing one of the saved auto-dial telephone numbers. This can be, for example, pressing or engaging one or more of the buttons 18, e.g., the record button(s), a switch, or other means that is programmed or otherwise configured to ensure that the telephone 10 does not auto-dial when taken off hook. Alternatively, the handset 14 cord could be unplugged prior to it being taken off-hook to prevent the telephone 10 from automatically dialing one of the saved auto-dial telephone numbers. In this configuration, a battery or other energy storage means could be used to maintain power to the handset 14 while the cord is unplugged. When the recording is finished, the telephone 10 can be restored back to normal operation.

If it is determined in step 420 that the record button is not actuated, then the process proceeds to step 430 in which it is determined if a button 18, e.g., the fourth button in the right-most column 17C, designated for activating a “SEND” timer function of the telephone 10 has been actuated. The “SEND” timer function can set a timer for automatically playing the location message that has been recorded and saved to memory, e.g., the message recorded in step 422 and saved in step 426.

If a positive determination is made, in step 430 then the process proceeds to step 432 in which a send timer, e.g., a time period after which the telephone 10 automatically actuates the SEND button after being placed off-hook, is started and the process proceeds to step 434. The send timer can be one of off (e.g., no timer), short time period (e.g., 5 seconds), or long time period (e.g., 1 minute). Alternatively, if a negative determination is made in step 430 then the process also proceeds to step 434.

In step 434, the telephone 10 determines which memory button 18, e.g., which one of the buttons in the middle column 17B, associated with an auto-dial telephone number is actuated. In this regard, each of the auto-dial buttons of the middle column 17B are scanned sequentially to determine which one of the buttons 18 is actuated. Upon determining which auto-dial button 18 is actuated, the process proceeds to step 436 and the telephone 10 places a call to the telephone number saved for the auto-dial button 18 that is actuated and then proceeds to steps 438 and 440 in which the send timer and send button are respectively monitored.

More specifically, in step 438, the telephone 10 determines if the send timer, which was activated in step 432, has elapsed. If a negative determination in made in step 438, then the process proceeds returns back to step 438 so that the timer is continuously monitored until the timer has elapsed. If a positive determination is made in step 438 then the process proceeds to step 442 and the telephone 10 plays the location message that was recorded and saved to memory, e.g., during steps 422 and 426, and then the process proceeds to end. In this regard, the recorded message can be played through the telephone 10 to the individual, service, or operator that was called during step 436. This functionality is colloquially referred to herein as the “LOCATION ANNOUNCEMENT” feature. It is noted that if the send timer is not active, e.g., it was not activated in step 432, then the telephone 10 need not perform step 438 as there is no timer to continuously monitor, but instead can proceed to the end for that branch of the process. For example, prior to proceeding to step 438, the telephone 10 can optionally determine if the send timer has been activated, and if a negative determination is made then that branch of the process can proceed to end. In step 440, the telephone 10 determines if the send button 19 is actuated, e.g., if a user (caller) has manually/mechanically actuated the send button 19. If a negative determination is made in step 440, then the process returns back to step 440 and continues to monitor the send button 19. If a positive determination is made in step 440, then the process proceeds to step 442 and the telephone 10 plays the location message that was recorded and saved to memory, and then proceeds to end. That is, a positive determination at step 440 indicates that the “LOCATION ANNOUNCEMENT” feature has been activated.

Accordingly, the “LOCATION ANNOUNCEMENT” feature of the telephone 10 provides for the automatic or manual playing of a recorded message that announces the location of the telephone 10 to the individual, service, or operator that was called and is currently on the line. This functionality can be activated by pressing the send button 19, e.g., the telephone 10 can play the recorded message to announce the location once the send button 19 is actuated. Alternatively, this functionality can be activated after a predetermined period of time has elapsed after the handset 14 has been taken off-hook, which is an electronic equivalent of responding to a mechanical actuation of the send button 19, e.g., by a caller pressing the send button 19. The message may be verbally recorded by the installer using a recording associated button 18 on the telephone 10, as described above in connection with steps 420, 422, 424, 426 of FIG. 4. In some embodiments, the location message is automatically played after the handset 14 is off-hook for a specific time, e.g., after the send timer has expired (which can be, for example, ten seconds), to ensure the emergency operator is listening. When combined with the “HOT MIC” feature, the “LOCATION ANNOUNCEMENT” feature enables an emergency operator to contact a facility or locale to gather further information before determining whether an emergency response is necessary or what emergency services are necessary, and/or provides the emergency operator or other receiving party with the known location to which the emergency services should be directed.

The present disclosure also includes a “HOT MIC” feature in which the microphone 20 gain is increased in situations where a user has dropped the handset 14 of the telephone 10, which can indicate that the user is in immediate danger or has fled. As previously noted, the handset 14 can include a position sensor 22 to determine if the handset 14 has been dropped. For example, the sensor 22 may be configured to detect, by any suitable means, when the handset 14 is upside down or inverted. In such a scenario, the microphone gain is increased significantly so that a dialed emergency operator can monitor activity near the telephone 10 (e.g., hear what is being shouted to evaluate the situation, judge a size of a nearby crowd, etc.). The increased microphone gain allows the emergency operator to better evaluate a situation by hearing voices further from the phone than the caller before determining whether an emergency response is necessary or which emergency services should be contacted.

By way of non-limiting example, sensor 22 may include a metal component on a pivot such that the sensor 22 can detect the metal component rotating or otherwise moving about the pivot when a caller drops the handset 14. In some embodiments, the sensor 22 can either create an electronic contact or activate a mechanical, magnetic, or optical switch. The sensor 22 can include a loose metal component in a channel that creates the electronic contact or activates the mechanical, magnetic, or optical switch. For example, the sensor 22 may include a steel ball in a plastic channel. Alternatively, the sensor 22 can employ the pull of gravity and sense a pull on a modular connector due to the weight of a hanging handset 14. In some embodiments, the sensor 22 can include a magnetic switch. Additionally and/or alternatively, the sensor 22 can be an accelerometer, tilt switch, gyroscope, hall effect sensor, or other appropriate mechanism for determining a change in position of the handset 14.

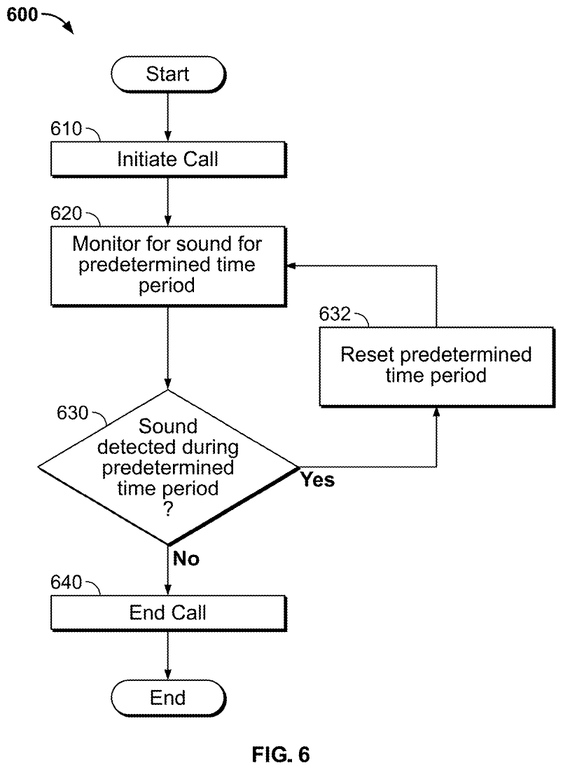

FIG. 5 is a flowchart of a process 500 for the “HOT MIC” feature of the telephone 10 of the present disclosure, which can be performed whenever the telephone 10 is taken off-hook. In step 510, the sensor 22 determines if the handset 14 is upside-down. If a negative determination is made, e.g., the headset is in the correct position, then the process ends or returns to the start to continue monitoring while the handset 14 is off-hook. If a positive determination is made in step 510, then the process proceeds to step 520 in which the gain of the microphone 20 is increased. Then, in step 530, the speaker 21 (e.g., earpiece) of the handset 14 can be optionally turned off to prevent howling or acoustic feedback and then the process ends. Additionally, after a predetermined amount of time, e.g., after activating the “HOT MIC” feature, the telephone 10 can activate an “AUTO DISCONNECT” feature as described below with regards to FIG. 6.

In this regard, the telephone 10 can include an “AUTO DISCONNECT” feature that prevents an abandoned call from blocking other persons from accessing emergency services in the event an emergency operator or other receiving party cannot force disconnection of the call. Abandoned calls may also tie up an internal Private Branch Exchange (PBX). The “AUTO DISCONNECT” feature is important in embodiments where multiple telephones 10 are placed in several hallways of a facility or locale and many telephones 10 may be activated during the same emergency. Accordingly, the telephone 10 can be programmed to automatically disconnect based on a timer or when detected sound stops. For example, when sound is no longer detected by the microphone 20, the controller 24 may engage the “AUTO DISCONNECT” feature if no sound continues for a predetermined time period, such as five, ten, or fifteen seconds.

FIG. 6 is a flowchart 600 of a process for the “AUTO DISCONNECT” feature of the telephone 10 of the present disclosure. A call is first initiated in step 610. Next, in step 620, the telephone 10, e.g., the central processing unit/microprocessor 24, monitors the call to determine if any sounds were detected by the microphone 20 during a predetermined time period, such as five, ten, or fifteen seconds. During this step, any detected sounds can also be compared to a threshold decibel level so that only sounds that exceed the threshold decibel level are considered. In step 630, it is determined if a sound, e.g., a sound over the threshold decibel level, was detected during the predetermined time period. If a positive determination is made, which indicates that the call is not abandoned, then in step 632 the predetermined time period is reset and the process resumes at step 620. If a negative determination is made in step 630, then the call is ended in step 640 and the process ends.

The telephone 10 can also detect if a call has been answered, and, if not, momentarily disconnect to re-establish a dial tone and then automatically dial an alternative number saved to memory, e.g., one of the telephone numbers associated with a different memory button 18. For example, the telephone 10 can auto-dial an emergency number, as previously discussed, and determine if ringing has occurred for longer than a predetermined time period, e.g., 10 seconds, without the call being answered. If the ringing time period exceeds the predetermined time period, then the telephone 10 can momentarily disconnect to re-establish a dial tone and then automatically dial an alternative number saved to memory. Alternatively, the telephone 10 can determine that the line is busy, disconnect, re-establish a dial tone, and automatically dial an alternative number saved to memory. The foregoing should be understood to be non-limiting examples, and the telephone 10 can use other methods for determining if a call has been answered or if a line is busy.

It should be understood that the telephone 10 need not include all of the foregoing functionalities, but instead can have one or more of the functionalities, which can be combined based on end-user needs. For example, a basic model of the telephone 10 can include only the single number auto-dial for emergency use functionality, while more advanced versions can also incorporate the timer functionality, the “HOT MIC” functionality, the “AUTO DISCONNECT” functionality, and/or the “LOCATION ANNOUNCEMENT” functionality. Additionally, alternative configurations of the telephone 10 are contemplated by the present disclosure. For example, the buttons can be placed in different positions depending on the telephone model. The telephone 10 may be colored red to indicate that the telephone 10 is to be used in case of emergency. Moreover, the telephone 10 can be provided in any form or configuration suitable to perform the foregoing functions.

Having thus described the present disclosure in detail, it is to be understood that the foregoing description is not intended to limit the spirit or scope thereof.

What is claimed is:

1. An emergency telephone, comprising:
a speaker;
a microphone;
an activation mechanism configured to be placed in at least a first state and a second state; and
a memory storing a programmed telephone number,
wherein when the activation mechanism is in the first state the emergency telephone is inactive, and when the activation mechanism is in the second state the emergency telephone is activated and automatically places a call to the programmed telephone number.

2. The emergency telephone of claim 1, comprising:
a handset, the handset including the speaker and the microphone,
wherein when the handset is in a resting position the activation mechanism is positioned in the first state and the emergency telephone is inactive, and when the handset is removed from its resting position the activation mechanism changes from the first state to the second state causing the emergency telephone to be activated.

3. The emergency telephone of claim 2, comprising a sensor configured to detect that the handset has been dropped.

4. The emergency telephone of claim 3, wherein the emergency telephone increases a gain of the microphone when the sensor detects that the handset has been dropped.

5. The emergency telephone of claim 3, wherein the sensor is at least one of an electrical sensor, a mechanical sensor, a magnetic sensor, an electrical switch, an optical switch, a magnetic switch, an accelerometer, a tilt switch, a gyroscope, and a hall effect sensor.

6. The emergency telephone of claim 1, wherein the activation mechanism is at least one of an electrical sensor, a mechanical sensor, a magnetic sensor, an electrical switch, an optical switch, a magnetic switch, an accelerometer, a tilt switch, a gyroscope, a hall effect sensor, a button, a motion sensor, a tilt sensor, a capacitive sensor, a proximity sensor, a push plate, and a pull cord.

7. The emergency telephone of claim 1, wherein the memory stores a plurality of programmed telephone numbers, the emergency telephone includes a means for selecting one of the plurality of programmed telephone numbers, and the emergency telephone automatically places a call to the selected programmed telephone number when the activation mechanism is placed in the second state.

8. The emergency telephone of claim 4, wherein the means for selecting includes a plurality of buttons, each button is associated with one of the plurality of programmed telephone numbers, and each button can be individually actuated to select the associated telephone number.

9. The emergency telephone of claim 1, wherein the memory stores a message and the emergency telephone plays the message after automatically placing the call to the at least one programmed telephone number.

10. The emergency telephone of claim 9, wherein the message is customizable and can be recorded by a user with the microphone.

11. The emergency telephone of claim 9, wherein the emergency telephone plays the voice message after a programmed amount of time has elapsed.

12. The emergency telephone of claim 1, comprising a processor in communication with the memory, the processor:
monitoring the microphone for sound;
determining if sound has been captured by the microphone during a predetermined time period; and
ending a current call if sound has not been detected during the predetermined time period.

13. The emergency telephone of claim 12, wherein the processor determines if captured sound is greater than a threshold decibel level and disregards the captured sound if the decibel level of the captured sound is not greater than the threshold decibel level.

14. The emergency telephone of claim 1, comprising a processor in communication with the memory, the processor:
determining an elapsed call time, the elapsed call time being how much time has elapsed since the call has been placed;
determining whether the call has been answered;
determining whether the elapsed call time exceeds a threshold;
disconnecting the call if the call has not been answered and the elapsed call time exceeds a threshold; and
automatically placing a call to a second programmed telephone number after disconnecting.

15. A method of placing an emergency call with an emergency telephone having a speaker, a microphone, an activation mechanism, and a memory storing a programmed telephone number, comprising:
causing the activation mechanism to change from a first state in which the emergency telephone is inactive to a second state in which the emergency telephone is activated; and
placing a call to the programmed telephone number stored in a memory automatically upon the activation mechanism being placed in the second state.

16. The method of claim 15, wherein causing the activation mechanism to change from a first state in which the emergency telephone is inactive to a second state in which the emergency telephone is activated includes:
removing a handset of the emergency telephone from a resting position to cause the activation mechanism to change from the first state to the second state.

17. The method of claim 16, comprising:
detecting that the handset has been dropped; and
increasing a gain of the microphone upon detecting that the handset has been dropped.

18. The method of claim 15, wherein the activation mechanism is at least one of an electrical sensor, a mechanical sensor, a magnetic sensor, an electrical switch, an optical switch, a magnetic switch, an accelerometer, a tilt switch, a gyroscope, a hall effect sensor, a button, a motion sensor, a tilt sensor, a capacitive sensor, a proximity sensor, a push plate, and a pull cord.

19. The method of claim 15, comprising:
selecting one of a plurality of programmed telephone numbers stored in the memory using a means for selecting,
wherein the programmed telephone number to which the call is placed is the programmed telephone number selected using the means for selecting.

20. The method of claim 19, wherein the means for selecting includes a plurality of buttons, each button is associated with one of the plurality of programmed telephone numbers, and each button can be individually actuated to select the associated telephone number.

21. The method of claim 15, comprising:
playing a message stored to the memory after placing the call to the programmed telephone number.

22. The method of claim 21, wherein the message is customizable and can be recorded by a user with the handset.

23. The method of claim 15, comprising:
determining that a programmed amount of time has elapsed,
wherein playing the message occurs upon determining that the programmed amount of time has elapsed.

24. The method of claim 15, comprising:
monitoring the microphone for sound;
determining if sound has been captured by the microphone during a predetermined time period; and
ending a current call if sound has not been detected during the predetermined time period.

25. The method of claim 24, comprising:
capturing sound with the microphone;
comparing a decibel level of the captured sound to a threshold decibel level; and
disregarding the captured sound if the decibel level of the captured sound is less than the threshold decibel level.

26. The method of claim 25, comprising:
determining an elapsed call time, the elapsed call time being how much time has elapsed since the call has been placed;
determining whether the call has been answered;
determining whether the elapsed call time exceeds a threshold;
disconnecting the call if the call has not been answered and the elapsed call time exceeds the threshold; and
automatically placing a call to a second programmed telephone number after disconnecting.
